(19) United States
(12) Patent Application Publication
(10) Pub. No.: US 2010/0229360 A1
(43) Pub. Date: Sep. 16, 2010

(54) METHOD AND DEVICE FOR SETTING GEMSTONES

(75) Inventor: Roger WILLIAMS, Harrisville, NH (US)

Correspondence Address: WILMERHALE/BOSTON, 60 STATE STREET, BOSTON, MA, 02109, US

(73) Assignee: Findings, Inc.

(21) Appl. No.: 12/402,197

(22) Filed: Mar. 11, 2009

(51) Int. Cl. B23P 5/00

(52) U.S. Cl. 29/10

(57) ABSTRACT

In accordance with one or more embodiments of the invention, a method and apparatus for setting gemstones. The apparatus includes a frame, an adjusting screw, and a substantially self-centering thimble. The method includes disposing at least a portion of a setting into a thimble cavity, disposing a gemstone into the prongs of the setting, disposing the thimble on a fixed jaw of a setting device, rotating the grip, and further actuating the forming tool towards the thimble to set the gemstone.

### BACKGROUND OF THE INVENTION

1. Field of Invention

The present invention generally relates to methods and devices for setting gemstones. More specifically, the present invention relates to methods and devices for setting a range of sizes of gemstones without the need to change the tool components.

2. Description of Related Art

Many gemstones are secured in place in jewelry settings using formed metal or metal projections that extend over the top of the stone table to hold the stone against a seat comprising a recessed edge or projection within a mounting structure.

A typical stone mounting or setting structure for precious or semi-precious stones such as diamonds, is a solitary tiffany setting or cage which comprises a series of spaced apart supports commonly known as prongs. Standard stone settings generally use 4 or 6 prongs. The prongs generally extend up and outward at an angle from a mounting surface, such as a ring or a stud base, and are generally grouped symmetrically about a central mounting location.

A gemstone to be mounted is traditionally placed in a setting, with the ends of the prongs extending above the stone. The prongs must then be bent over an outer edge of the stone. Great care must be taken during this step to avoid damaging the stone. If the tools used for bending the prongs drive against the stone during setting, they create a risk of damaging the stone.

### BRIEF SUMMARY OF EMBODIMENTS OF THE INVENTION

In accordance with one or more embodiments of the invention, a device for setting gemstones is disclosed, the device comprising a frame having a first end and a second end, an adjusting screw having a first end and a second end, and a substantially self-centering thimble.

In accordance with one or more embodiments of the invention, a method of setting a gemstone is disclosed, the method comprising disposing at least a portion of a setting into a cavity of a thimble, wherein the setting includes prongs, disposing a gemstone into the prongs of the setting, disposing the thimble on a fixed jaw of a setting device, where the setting device includes a frame, a setting screw engaged with the frame, and the thimble, wherein a first end of the setting screw includes a grip and a second end of the setting screw includes a forming tool, and wherein the forming tool includes a concave inner surface, rotating the grip to bring the forming tool into contact with the setting so that the gemstone is substantially self-centered by the longitudinal axis of the thimble being brought into substantial alignment with the longitudinal axis of the setting screw, wherein alignment is achieved by contact between the concave inner surface of the forming tool and one or more prongs of the setting, and further actuating the forming tool towards the thimble, wherein force is transferred through the grip to the prongs via the forming tool to deform the prongs of the setting towards a surface of the crown of the gemstone.

### BRIEF DESCRIPTION OF THE DRAWINGS

For a more complete understanding of various embodiments of the present invention, reference is now made to the following descriptions taken in connection with the accompanying drawings in which:

FIG. 1 is a perspective view of a setting device according to an embodiment of the invention.

FIG. 2 is a perspective view of a setting device, along with a gemstone in a setting, according to another aspect of the invention.

FIG. 3 is a perspective view of a setting device, along with a gemstone in a setting, engaged in the method according to an embodiment of the invention.

FIG. 4 is a perspective view of a setting device according to another aspect of the invention.

FIGS. 5A through 5E are side views illustrating the effects on a setting according to another aspect of the invention, shown in relation to a gemstone which is set in the setting.

FIG. 6 is a side view illustrating a variety of sizes of gemstones set in settings according to some aspects of the invention.

FIGS. 7A through 7C illustrate adjusting screws and forming tools according to some aspects of the invention.

### DETAILED DESCRIPTION OF THE PREFERRED EMBODIMENTS

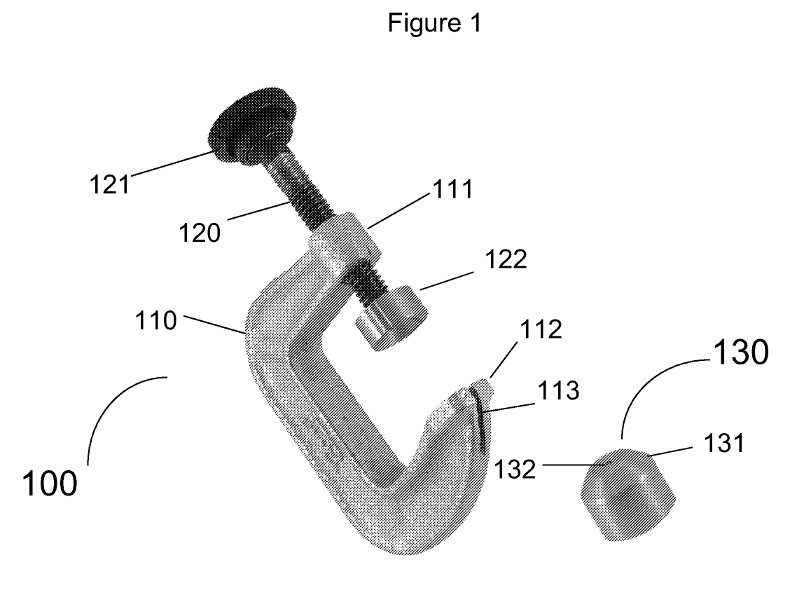

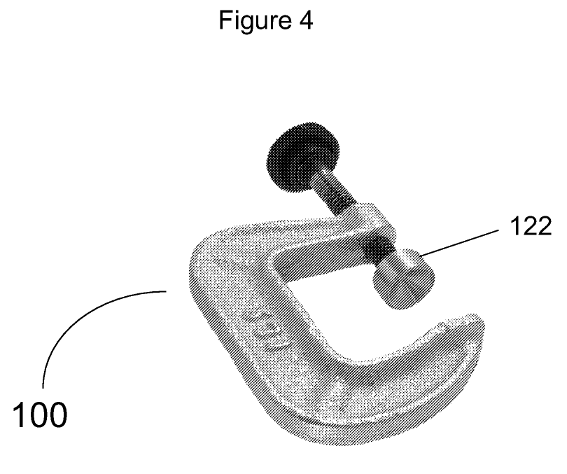

FIG. 1 illustrates a perspective view of a setting device according to one embodiment. The setting device 100 includes frame 110, adjusting screw 120, and thimble 130. Frame 110 can be shaped similarly to the frame of a c-clamp, as illustrated in FIGS. 1 through 4, or can be shaped in a variety of different ways. The distal end 111 of the throat of frame 110 has a threaded opening through which adjusting screw 120 can be screwed. The proximal end of the throat of frame 110 is a fixed jaw 112. Fixed jaw 112 is defined by jaw cavity 113. Adjusting screw 120 extends through the distal end 111 of the throat of frame 110, and the threads of adjusting screw 120 engage with the threads of distal end 111, i.e. via complimentary threading. The distal end of adjusting screw 120 comprises grip 121. Grip 121, as illustrated in FIGS. 1 through 4, can be a knob that is mated with adjusting screw 120 such that a 360 degree rotation of the knob rotates adjusting screw 120 360 degrees. Grip 121 can also comprise other structures, such as a sliding bar or any other type of handle by way of nonlimiting examples. The proximal end of adjusting screw 120 comprises forming tool 122. The distal end of forming tool 122 is attached to the proximal end of adjusting screw 120. The proximal end of forming tool 122, as illustrated in FIGS. 1 and 4, has a generally concave inner surface. In some embodiments, frame 110 is approximately 3″ to 4 inches long. In other embodiments, frames of larger or smaller size are contemplated. In some embodiments, forming tool 122 has a height of approximately 0.375 inches and a diameter of approximately 0.5 inches. In other embodiments, it is contemplated that forming tool 122 can be larger or smaller.

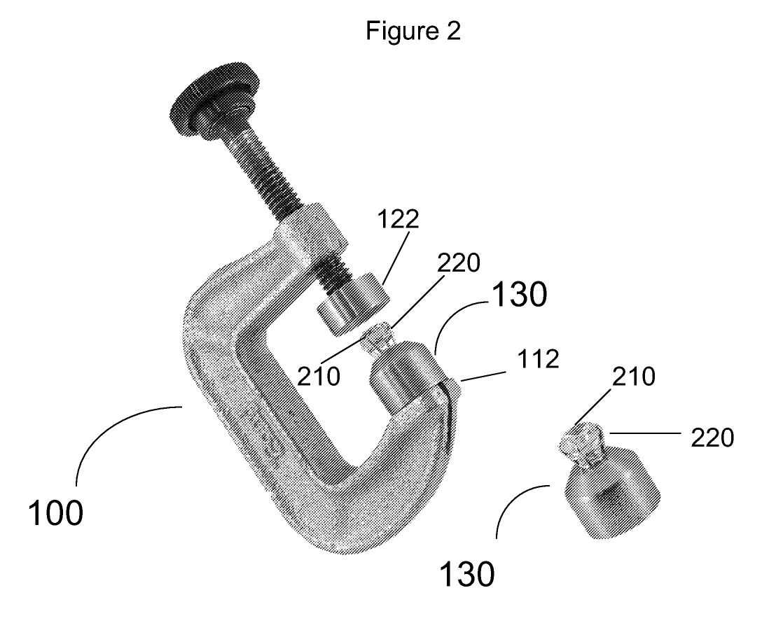

Thimble 130, as illustrated in FIGS. 1 and 2, has a generally cylindrical shape. In some embodiments, thimble 130 has a height of approximately 0.437 inches and a diameter of approximately 0.5 inches. In other embodiments, it is contemplated that thimble 130 can be larger or smaller. In some but not all embodiments, the diameter of forming tool 122 and thimble 130 are substantially the same. Variations in the in the shapes of thimble 130 and/or forming tool 122 are also contemplated. For example, thimble 130 and/or forming tool 122 can be shaped to accommodate other jewelry styles, such as pendants, solitaire rings, and other styles.

Referring to FIG. 1, top portion 131 of thimble 130 is tapered such that the circumference of thimble 130 decreases from a bottom portion to a top portion 131. Top portion 131 of thimble 130 has a generally convex outer surface. In some embodiments, the circumference of the top surface of top portion 131 of thimble 130 is less than the inner circumference of the proximal end of forming tool 122. In such embodiments, upon actuation of adjusting screw 120, a top surface of top portion 131 of thimble 130 may penetrate a plane of the proximal end of forming tool 122.

In or near the center of thimble 130 is thimble cavity 132. Thimble cavity 132 extends longitudinally at least part way through thimble 130, and in some embodiments all the way through thimble 130. Thimble cavity 132 can be used, for example, to insert a portion of a stem of an earring into, and to hold that stem portion and minimize or prevent lateral movement of the earring stem when it is inserted into thimble cavity 132. As noted above, the systems and methods of the present invention can be used to set gemstones on not only earrings, but also other jewelry styles. Such other jewelry styles may include pendants or solitaire rings, by way of nonlimiting examples.

FIG. 2 illustrates a perspective view of a setting device, along with a gemstone set in a setting, according to an aspect of the invention. As illustrated in FIG. 2, gemstone 210 is shown after it has been set in setting 220. Gemstone 210 can be a diamond, or can be any other precious or semi-precious stone or mineral. Gemstone 210 could also be costume jewelry. According to an aspect of the current invention, stem 510 (not shown in FIG. 2) of setting 220 is inserted into thimble cavity 132 of thimble 130. Gemstone 210 is then placed into the top portion of setting 220, which is comprised of setting prongs 520. Thimble 130, with a top portion of setting 220 extending from the top of thimble cavity 132, is then placed onto fixed jaw 112. Grip 121 is then turned, which actuates forming tool 122 closer to gemstone 210 and thimble 130.

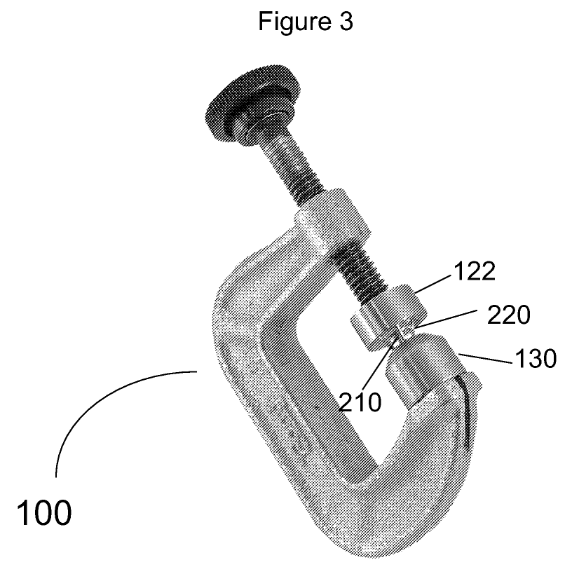

As illustrated in FIG. 3, as forming tool 122 is actuated closer to gemstone 210 and setting 220, forming tool 122 eventually comes into contact with setting 220. Forming tool 122 makes contact with setting prongs 520. In some aspects, thimble 130 is not fixed on fixed jaw 112, and thus can move laterally on the surface of fixed jaw 112. This available movement allows thimble 130 and setting 220 to self-center automatically. When thimble 130 is perfectly placed on fixed jaw 112, thimble cavity 132 is aligned with adjusting screw 120 such that they share a longitudinal center axis. In such circumstances, as forming tool 122 is actuated toward setting 220, each prong 520 on setting 220 makes contacts with forming tool 122 at substantially the same time. This is because each prong 520 in a given setting is preferably the same height as each other prong 520 in that setting, and the inner surface of forming tool 122 is preferably substantially radially uniform, meaning that the inner surface of forming tool 122 is preferably equidistant from the longitudinal axis of adjusting screw 120 at any given distance into the proximal end of forming tool 122 along the longitudinal axis of adjusting screw 120. When forming tool 122 is perfectly placed on fixed jaw 112, each prong 520 of setting 220 thus makes contact with forming tool 122 at substantially the same time.

As forming tool 122 is further actuated toward thimble 130, the downward force applied by forming tool 122 on prongs 520 deforms prongs 520 toward surfaces of the crown of gemstone 210. Because additional force is required for forming tool 122 to deform prongs 520 above the force required to actuate forming tool 122 into contact with prongs 520, this additional force is applied through grip 121. Grip 121 thus provides tactile feedback to a user turning grip 121. Upon further actuation of forming tool 122 after forming tool 122 begins to deform prongs 520, top portions of prongs 520 eventually make contact with the crown of gemstone 210. As prongs 520 make contact with the crown of gemstone 210, gemstone 210 is set into setting 220. After gemstone 210 is set in setting 220, any further actuation of forming tool 122 would tend to deform prongs 520 into surfaces of the crown of gemstone 210, providing additional tactile feedback to a user informing the user that gemstone 210 has been successfully set in setting 220.

Embodiments in which thimble 130 is not fixed on fixed jaw 112, i.e. in which thimble 130 movably contacts fixed jaw 112, provide for self-aligning gemstone setting. If thimble 130 is not perfectly placed on fixed jaw 112, i.e. if thimble cavity 132 is not aligned with adjusting screw 120 such that they share a longitudinal center axis, then fewer than all prongs 520 will make initial contact with forming tool 122. For example, one prong 520 may make contact with forming tool 122 first. Further actuation of forming tool 122 in these embodiments in which thimble 130 floats on fixed jaw 112 will apply a lateral force to prongs 520 that make contact with forming tool 122, and will result in thimble 130 moving toward alignment. Upon further actuation, thimble 130 is properly aligned with forming tool 122, and each prong 520 makes contact with forming tool 122 at substantially the same time.

FIG. 4 further illustrates setting device 100 with frame 110 and adjusting screw 120. From FIG. 4, the substantial radial uniformity of the inner surface of forming tool 122 can be seen more clearly.

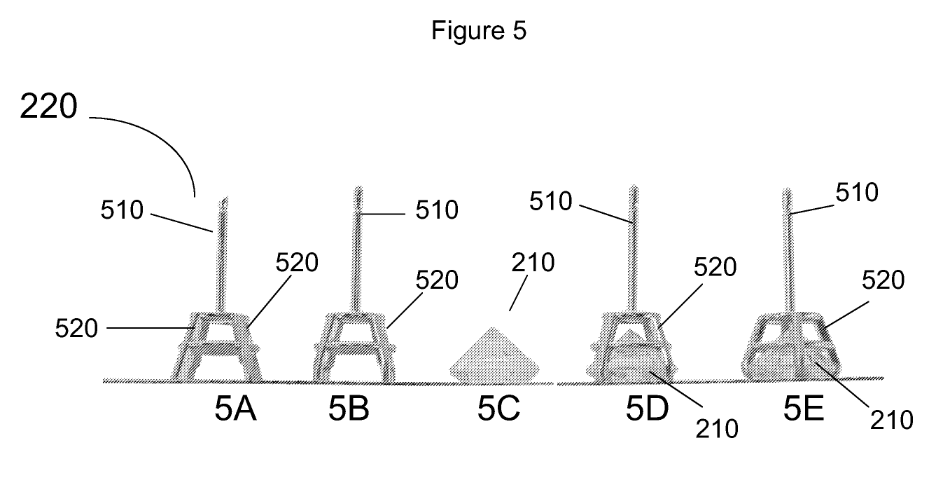

FIGS. 5A through 5E illustrate side views of settings 220 and gemstone 210. FIG. 5A illustrates setting 220, which comprises stem 510 and prongs 520, before force is applied to deform prongs 520. FIG. 5B illustrates setting 220 after some force has been applied by forming tool 122 to the ends of prongs 520. Alternatively, FIG. 5B illustrates setting 220 in its initial state. FIG. 5C illustrates gemstone 210. FIG. 5D illustrates additional deformation of prongs 520 toward the crown of gemstone 210. FIG. 5E illustrates a set gemstone, where prongs 520 have been deformed by forming tool 122 such that each prong 520 is in contact with the crown of gemstone 210, and gemstone 210 can not move relative to setting 220.

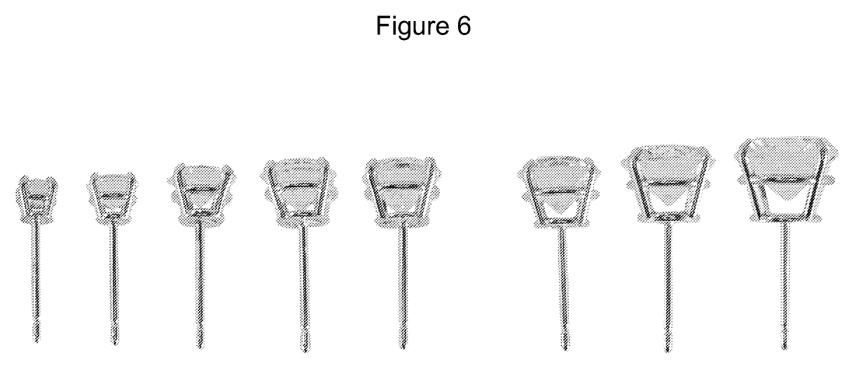

FIG. 6 is a side view illustrating a variety of sizes of gemstones 210 set in settings 220 according to aspects of the invention. From FIG. 6 it can be seen that a large variety of sizes of gemstones can be set by device 100.

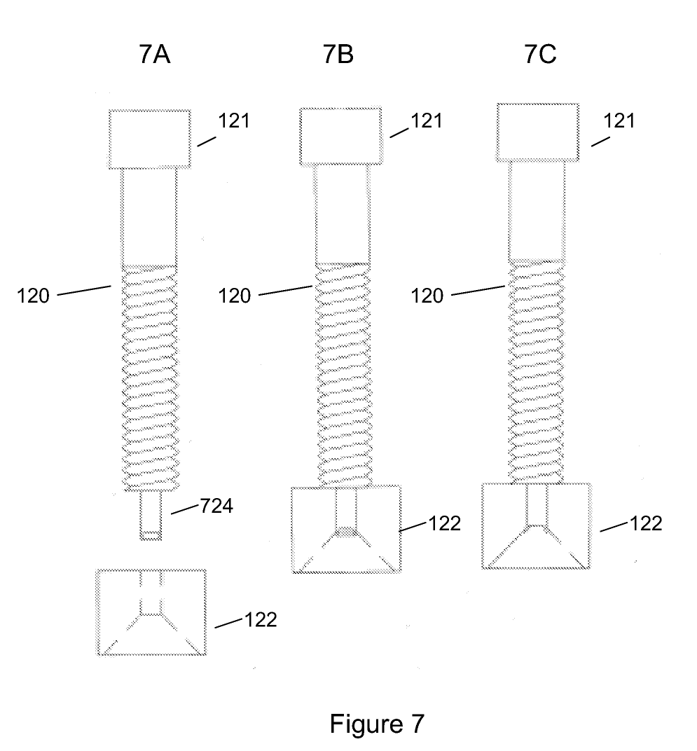

FIGS. 7A through 7C illustrate adjusting screws and forming tools according to some aspects of the invention. Referring to these figures, adjusting screw 120 includes grip 121, stem 724, and forming tool 122. Stem 724 engages with forming tool 122 as shown in FIGS. 7B and 7C. In some embodiments, stem 724 has a loose fit with forming tool 122, such that when a user rotates adjusting screw 120 by rotating grip 121, forming tool 122 does not rotate. In these embodiments, rotational force applied by a user through grip 121 and adjusting screw 120 is translated into substantially non-rotational vertical force applied by forming tool 122. As also illustrated in FIGS. 7B and 7C, stem 724 can be staked into forming tool 122 so that forming tool 122 stays in place on an end of adjusting screw 120. Forming tool 122 can be setting style specific. For example, the inner surface of forming tool 122 can be shaped to accommodate different shaped settings, including, by way of nonlimiting examples, oval, pear, emerald, princess, or marquis settings.

As will be realized, the inventions are capable of other and different embodiments and its several details may be capable of modifications in various respects, all without departing from the invention as set out in the appended claims. For example, the decorative ornament need not be mounted in a gem basket, but could be attached directly to the dapped support piece. Accordingly, the drawings and description are to be regarded as illustrative in nature and not in a restrictive or limiting sense with the scope of the application being indicated in the claims.

What is claimed is:

1. A device for setting gemstones, the device comprising:
a frame having a first end and a second end, the second end of the frame comprising a fixed jaw;
an adjusting screw having a first end, second end, and a longitudinal axis, the first end of the adjusting screw including a grip and the second end of the adjusting screw including a forming tool, the forming tool including a concave surface, and a portion of the adjusting screw rotatably engaging the first end of the frame such that rotation of the adjusting screw causes the forming tool to translate longitudinally relative to the fixed jaw; and
a substantially self-centering thimble, a top portion of the thimble being tapered to a generally convex shape complementary to the concave surface of the forming tool, at least a portion of the longitudinal center of the thimble comprising a cavity, the thimble movably contacting the fixed jaw so that compressive force conveyed to a workpiece disposed between the forming tool and the thimble will substantially self-center the workpiece such that the longitudinal axis of the cavity in the thimble is substantially aligned with the longitudinal axis of the adjusting screw;
wherein the grip provides tactile feedback so that a user of the device can sense the compressive force applied to the workpiece through the adjusting screw.

2. The setting device of claim 1, wherein the outer diameter of a top portion of the thimble is less than the inner diameter of a portion of the forming tool.

3. The setting device of claim 1, wherein engagement of the adjusting screw and the frame consists of complimentary threading.

4. The setting device of claim 1, wherein the fixed jaw of the frame is defined by a cavity and wherein the stem of a setting can engage with the cavity in the fixed jaw.

5. A method of setting a gemstone in a setting, the method comprising:
disposing at least a portion of a setting into a cavity of a thimble, the setting including prongs;
disposing a gemstone into the prongs of the setting, the gemstone having a crown;
disposing the thimble on a fixed jaw of a setting device, the setting device including a frame, a setting screw engaged with the frame, the thimble, and the fixed jaw, a first end of the setting screw including a grip and a second end of the setting screw including a forming tool, the forming tool including a concave inner surface, wherein rotation of the setting screw translates the forming tool relative to the fixed jaw;
rotating the grip to bring the forming tool into contact with the setting so that the gemstone is substantially self-centered by a longitudinal axis of the thimble being brought into substantial alignment with a longitudinal axis of the setting screw, wherein alignment is achieved by contact between the concave inner surface of the forming tool and one or more prongs of the setting; and
further rotating the grip to translate the forming tool towards the thimble, wherein force is transferred through the grip to the prongs via the forming tool to deform the prongs of the setting towards a surface of the crown of the gemstone.
